(19) United States
(12) Patent Application Publication
(10) Pub. No.: US 2016/0028664 A1
(43) Pub. Date: Jan. 28, 2016

(54) CHAT SYSTEM, KEY TELEPHONE UNIT, AND RECORDING MEDIUM

(71) Applicants: NEC Platforms, Ltd., Kawasaki-shi (JP); NEC CORPORATION, Tokyo (JP)

(72) Inventors: Nobuo NISHIDE, Tokyo (JP); Mitsuharu KASAHARA, Kawasaki-shi (JP)

(73) Assignees: NEC Platforms, Ltd., Kawasaki-shi (JP); NEC CORPORATION, Tokyo (JP)

(21) Appl. No.: 14/878,025

(22) Filed: Oct. 8, 2015

Related U.S. Application Data
(63) Continuation-in-part of application No. 14/600,110, filed on Jan. 20, 2015.

(30) Foreign Application Priority Data
Apr. 8, 2014 (JP) 2014-079150

(51) Int. Cl. H04L 12/58; H04L 29/08

(52) U.S. Cl. CPC H04L 51/043; H04L 67/104; H04L 67/24

(57) ABSTRACT

A chat system includes a key telephone unit and a plurality of user terminals connected to the key telephone unit. When the key telephone unit receives presence information including an IP address of the user terminal, it refers to a list in a list table, selects the received IP address in presence information, and transmits the presence information including the IP address to a recipient included in the list. Thus, the key telephone unit establishes peer-to-peer chat communication between the user terminal that has transmitted the IP address and the recipient. When the user terminal which is continuing a chat moves to a different user terminal, the chat is being continued by transmitting presence information including an IP address of the different user terminal to the key telephone unit and chat data are transferred between the user terminal and the different user terminal in a peer-to-peer connection.

This application is a Continuation-in-Part of U.S. application Ser. No. 14/600,110, filed Jan. 20, 2015, which is based upon and claims the benefit of priority from Japanese patent application No. 2014-79150, filed on Apr. 8, 2014, the disclosure of which is incorporated herein in its entirety by reference.

### TECHNICAL FIELD

The present invention relates to a chat system capable of having a chat without any chat server by using a key telephone unit, and the key telephone unit, and a program for the key telephone unit.

### BACKGROUND ART

Along with popularization of smart phones and the like, chat communication has frequently been used with smart phones and the like. A server for managing chat communication is required in order to construct a chat system for exchanging chats in real time between clients such as smart phones. The server always recognizes IP addresses of chat clients, so that each of the clients does not have to know an IP address of a companion client.

However, a small-sized office is reluctant or hesitant to adopt public network services for their business. Furthermore, a small-sized office faces high hurdles in cost, human resources for managing the system, and the like to prepare a server and construct its own chat system.

Patent Literature 1 (JP-A 2004-192331) discloses a communication terminal device, a communication server and communication method for real-time interactive communication such as chats. Specifically, Patent Literature 1 discloses a system capable of displaying images as well as texts in order to enhance realistic sensation of peer-to-peer (P2P) chat communication between personal computers. Thus, Patent Literature 1 discloses a communication system for providing a peer-to-peer chat service between personal computers via the Internet and also discloses a communication system for carrying out communication via both the Internet and a server.

### SUMMARY

However, the system disclosed in Patent Literature 1 cannot sufficiently satisfy demands on a chat system for small-sized offices or the like. In other words, small-sized offices are reluctant to use public network services, such as the Internet, and cannot accept the cost required to prepare their own server for a chat system.

It is, therefore, an exemplary object of the present invention to provide a chat system capable of solving at least one of the aforementioned problems.

Another exemplary object of the present invention is to provide a chat system suitable for a small-sized office and the like.

According to the present invention, there is provided a chat system which does not need a chat server by using a key telephone unit installed in a small-sized office and the like and a plurality of user terminals. Specifically, each user terminal can know an addressee or recipient IP address of a chat by adding the IP address of the addressee or recipient to presence information delivered by the key telephone unit. After acquisition of the IP address in each user terminal, it is possible to perform peer-to-peer communication between the user terminals and to thus establish chat communication.

More specifically, according to a first aspect of the present invention, there is provided a chat system comprising a plurality of user terminals assigned with IP addresses, respectively, and a key telephone unit accommodating the plurality of the user terminals, wherein:

the key telephone unit is configured to: receive presence information from a first user terminal in the plurality of the user terminals, the presence information including the IP address assigned to the first user terminal; refer to a list within a list table to pick up a second user terminal included in the list; transmit the presence information including the IP address received from the first user terminal to the second user terminal; and make the first and the second user terminals perform a chat communication in a peer-to-peer connection;

wherein;
when a user of the first user terminal moves from the first user terminal to a third user terminal,
   the third user terminal transmits, to the key telephone unit, presence information of the user which includes an IP address of the third user terminal and
   the key telephone unit refers to the list within the list table and transmits, to the second user terminal included in the list, the presence information including the received IP address of the third user terminal;
      wherein:
chat data between the first user terminal and the second user terminal are transferred from the first user terminal to the third user terminal in a peer-to-peer connection and are taken over as chat data between the third user terminal and the second user terminal, and the peer-to-peer chat communication between the first and the second user terminals is continued as a peer-to-peer chat communication between the third and the second user terminals.

With this structure, it is possible to switch the user terminals from one to another during chat communication and to continue the chat communication.

According to a second aspect of the present invention, there is provided a key telephone unit accommodating a plurality of user terminals assigned with IP addresses, respectively, the key telephone unit being configured to:
receive presence information from a first user terminal in the plurality of the user terminals, the presence information including the IP address assigned to the first user terminal;
refer to a list within a list table to pick up a second user terminal included in the list;
transmit the presence information including the IP address received from the first user terminal to the second user terminal; and
make the first and the second user terminals perform a chat communication in a peer-to-peer connection;
   wherein;
when a user of the first user terminal is moves from the first user terminal to a third user terminal,
   the key telephone unit is further configured to:
      receive, from the third user terminal, presence information of the user which includes an IP address of the third user terminal; refer to the list within the list table; and transmit, to the second user terminal included in the list, the presence information including the received IP address of the third user terminal; and make the peer-to-peer chat communication between the first and the second user terminals continue as a peer-to-peer chat communication between the third and the second user terminals.

According to a third aspect of the present invention, there is provided a non-transitory computer readable recording medium comprising a program which is used in the key telephone unit recited in the second aspect to respond to the presence information including the IP address received from the first user terminal, to select the second user terminal from the list table, and to output the presence information including the received IP address to the second user terminal.

### Advantageous Effect

According to exemplary embodiments of the present invention, there is obtained a chat system which performs chat communication without using a chat server, namely, in a server-less fashion. In other words, the exemplary embodiments of the present invention can realize the chat system which uses the key telephone unit including a private branch exchange.

### BRIEF DESCRIPTION OF THE DRAWINGS

FIG. 1 is a block diagram explanatory of the concept of a general chat system;

FIG. 2 is a block diagram showing a chat system according to a first exemplary embodiment of the present invention;

FIG. 3 is a block diagram showing a chat system according to a second exemplary embodiment of the present invention;

FIG. 4 is a block diagram showing a specific arrangement of the chat system illustrated in FIG. 2;

FIG. 5 is a diagram showing an instance of a buddy list table stored in a key telephone unit illustrated in FIG. 4; and

FIG. 6 is a diagram showing an instance of an IP address table stored in a user terminal.

### EXEMPLARY EMBODIMENT

First, a general chat system will be described in order to clarify differences between a chat system according to the present invention and the general chat system.

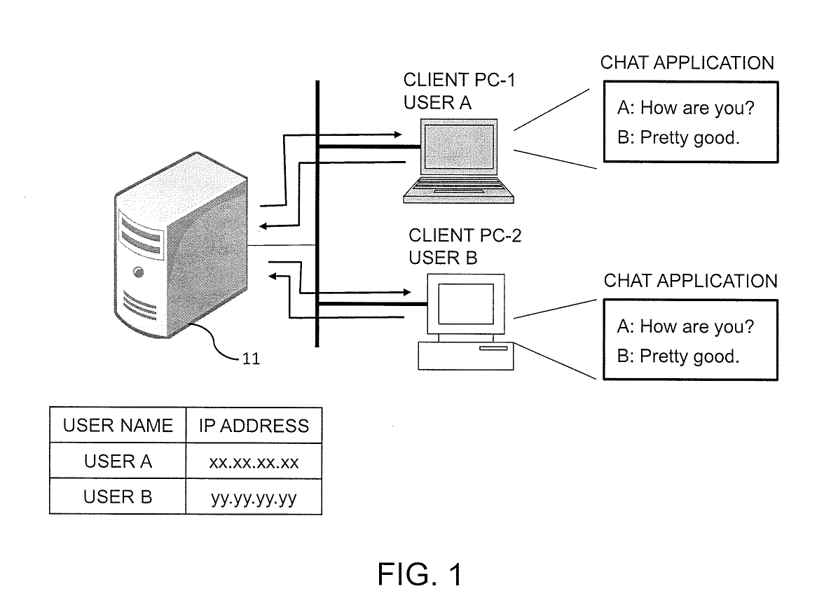

FIG. 1 exemplifies such a general chat system. The illustrated chat system includes a chat server 11 and a plurality of client terminals, e.g., personal computers (hereinafter referred to as client PCs) (PC-1 and PC-2 in this illustrated example). The chat server 11 manages IP addresses of the client PCs connected to the chat server 11. Therefore, the client PC-1 does not need to recognize the IP address of the client PC-2 as a chat addressee or recipient. However, the illustrated chat system requires the chat server 11 to be provided. Thus, this chat system is not suitable for small-sized offices.

Specifically, the chat server 11 should store all of IP addresses assigned to a whole of user terminals for performing chat communication, together with contents of each chat. Therefore, installing the chat server is not economically effective in a small-sized office which accommodates a restricted or small number of clients.

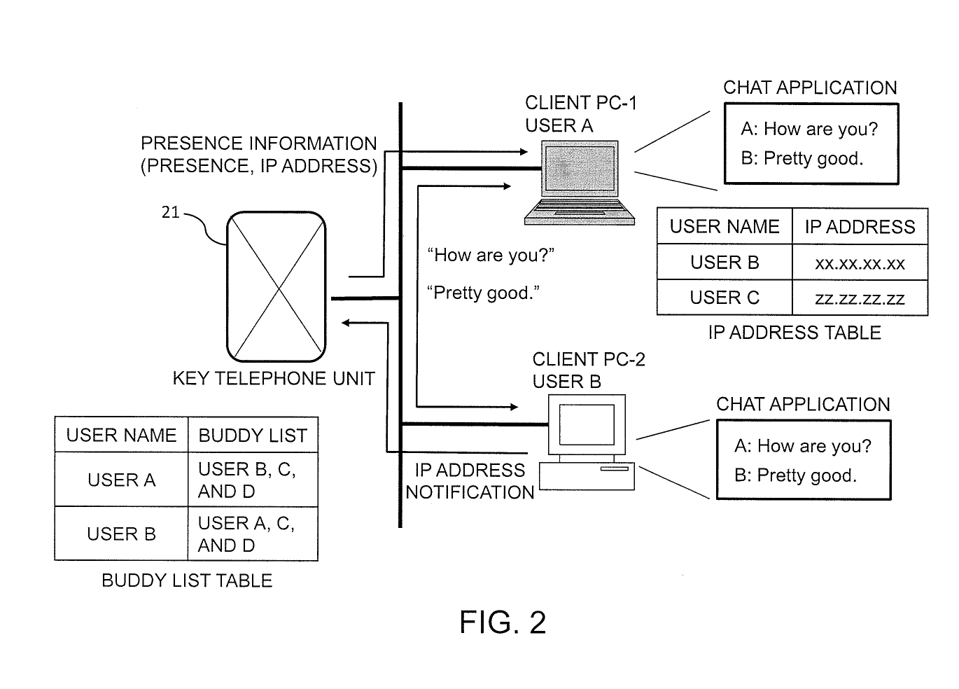

FIG. 2 shows a chat system according to a first exemplary embodiment of the present invention. The illustrated chat system includes a key telephone unit 21 and a plurality of client PCs connected to the key telephone unit 21. In general, it is to be noted that the key telephone unit 21 has a presence server alone but does not have any chat server.

The illustrated key telephone unit 21 is specified by distributing IP addresses as part of data of presence information. Herein, the presence information is representative of a present state of an addressee or recipient. Taking this into consideration, the first exemplary embodiment of the present invention is directed to achieving the chat system which utilizes the presence information of the key telephone unit which accommodates a plurality of telephone sets without any chat server.

According to the first exemplary embodiment of the present invention, the key telephone unit 21 connects or accommodates a plurality of user terminals (for example, personal computers (abbreviated to PC below)) in addition to the telephone sets and includes a presence server. It is assumed that client IP addresses are assigned to the plurality of the PC's to be connected to a network.

In the chat system according to the first exemplary embodiment of the present invention, the key telephone unit 21 distributes presence information which includes an IP address to a client PC-1 (user terminal of a user A). The client PC-1 (the user terminal of user A) acquires the IP address of a client PC-2 (user terminal of a user B). Thus, the client PC-1 and the client PC-2 are communicable with each other. Thus, the key telephone unit 21 has a function of distributing the IP address included in the presence information while each of the clients PC-1 and PC-2 receives the presence information including the IP address and has a function of detecting the IP address included in the presence information to know the IP address of the addressee or recipient for chatting.

Here, the presence information is defined as information indicating the current state of each client PC (or its user) (for example, online, offline, tea break, and the like). The presence information can be generated based on various kinds of information such as a state change notification transmitted automatically and/or manually from each client PC, pre-registered schedule information, monitoring results by the key telephone unit 21, and a response to an inquiry from the key telephone unit 21.

The illustrated key telephone unit 21 includes a buddy list table, in which buddy lists for the user terminals of the users A and B are stored. In the illustrated example, a buddy list for the client PC-1 of the user A includes the user terminals of users B, C, and D (as indicated by “User B, C, and D”), and a buddy list for the user terminal (namely, PC-2 of the user B) includes the user terminals of the users A, C, and D (as indicated by “User A, C, and D”).

Now, an operation of the chat system shown in FIG. 2 will be described. It is assumed that the user terminal (client PC-2) of the user B starts a user chat program of the client PC-2. In this case, when the client PC-2 of the user B logs in, the key telephone unit 21 is notified of the IP address of the client PC-2. Therefore, the key telephone unit 21 detects that the state of the client PC-2 has been changed.

The presence information transmitted from the illustrated key telephone unit 21 includes the IP address of the client PC-2 of the user B as well as the presence (online, offline, tea break, and the like) of the user B.

Thus, the illustrated key telephone unit 21 has a function of starting a chat program for users, receiving an IP address from a user terminal or client PC (for example, the PC-2 of the user B), referring to a buddy list corresponding to the IP address within the buddy list table, and transmitting the IP address of the received user terminal of the user B to one or more addressees or recipients in the buddy list. In this case, the IP address which is included in the presence information is transmitted from the key telephone unit 21.

In other words, the illustrated key telephone unit 21 operates in accordance with a key telephone unit program which is configured to select one or more recipient user terminals from the buddy list table in response to an IP address received from the user terminal (for example, PC-2 of the user B) and to transmit presence information including the received IP address assigned to the user B to the recipient user terminal of, for example, user A.

The user terminal namely, client PC-1 of the user A that has received the presence information can transmit chat data (for example, “How are you?”) to the IP address of the user terminal, namely, client PC-2 of the user B. Namely, each of the user terminals of users A and B has an IP address table which stores IP addresses corresponding to names of user terminals listed in the buddy list table of the key telephone unit 21. The illustrated IP address table of the user terminal, namely, PC-1 of the user A stores IP addresses corresponding to the user terminals of the users B and C.

When the client PC-2 of the user B receives the chat data, it can read and acquire an IP address of the client PC-1 of the user A which is a sender of the received chat data. The client PC-2 of the user B directly transmits chat data (for example, “Pretty good”) to the client PC-1 of the user A in the peer-to-peer connection.

As mentioned above, the chat data between the user terminals of the users A and B are directly transmitted and received between the user terminals A and B in the peer-to-peer connection without passing through the key telephone unit 21.

Thus, in this embodiment of the chat system according to the present invention, a chat program for each of the user terminals of the users A and B has a function of receiving presence information which includes its own IP address and which is transmitted from the key telephone unit 21. Specifically, the chat program for each user terminal, namely, the user terminal chat program of the users A and B includes a step of receiving presence information including an IP address of another user terminal on having a chat and a step of reading out another IP address assigned to another user terminal communicated with each user terminal.

Thus, in this embodiment, peer-to-peer chat communication can be established between client terminals of users by adding an IP address to presence information and distributing the presence information from the key telephone unit 21 to each user. Since no chat server is required in this system and the key telephone unit 21 can effectively be utilized to execute a chat communication, the cost for installing and maintaining the system can be reduced for a small-sized office.

In the example shown in FIG. 2, the description is directed to the case where the user terminal of the user A is in an online state. However, the present invention is applicable to a case where either one of the user terminals of users A and B is in an offline state. To this end, the chat system according to the present invention may have a memory device which is equipped with a sender user terminal and which cooperates with presence information to store chat data when a chat recipient is put into an offline state (such as a power off state, a chat program off state of the chat recipient). According to this structure, offline chat communication can be realized by transmitting the chat data stored in the memory device from the sender user terminal to the recipient user terminal when the recipient user terminal is put into or returned back to an online state.

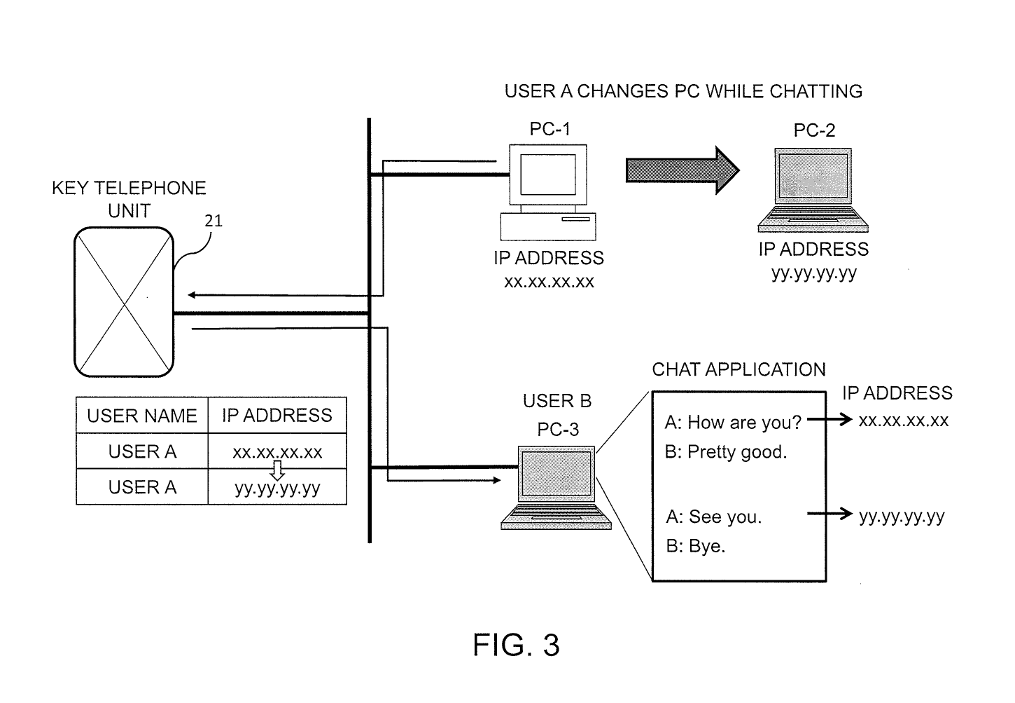

FIG. 3 shows a chat system according to a second exemplary embodiment of the present invention. In this embodiment, it is assumed that a user A moves from a client PC-1 of an IP address of xx.xx.xx.xx to a client PC-2 of an IP address of yy.yy.yy.yy while the user A is chatting with a client PC-3 of a user B. For convenience of description, the PC-1 of the user A and the PC-3 of the user B may be called first and second user terminals, respectively, while the PC-2 of the user A may be called a third user terminal.

In this case, the IP address assigned to the client PC-2 of the user A is transmitted from the client PC-2 to the key telephone unit 21. Responsive to the IP address of the client PC-2 of the user A, the key telephone unit 21 accesses an entry of the table assigned to the user A and rewrites the IP address of xx.xx.xx.xx into yy.yy.yy.yy.

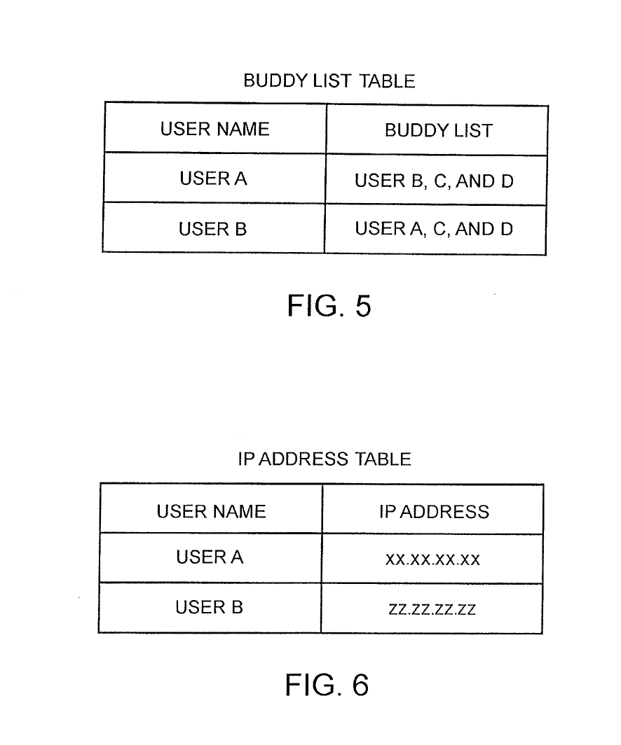

In the exemplary embodiment shown in FIG. 3, the client PC-2 of the user A transmits the presence information including the IP address yy.yy.yy.yy assigned to the client PC-2 to the key telephone unit 21. Responsive to the presence information, the key telephone unit 21 rewrites the IP address stored in the table of the user A into the IP address yy.yy.yy.yy. Thereafter, the key telephone unit 21 refers to the buddy list illustrated in FIG. 5 and detects the client PC-3 of the user B included in the buddy list to transmit the presence information including the IP address yy.yy.yy.yy of the client PC-2 to the client PC-3 included in the buddy list.

When the presence information which includes the IP address of “yy.yy.yy.yy” assigned to the client PC-2 is received, the chat program for the user terminal installed in the client PC-3 makes the client PC-3 continue the chat after changing the recipient IP address to the recipient IP address of “yy.yy.yy.yy”.

In the exemplary embodiment, chat data are transferred from the client PC-1 of the user A to the client PC-2 of the user A in the peer-to-peer connection. In other words, the chat data are taken over between the client PC-1 of the user A and the client PC-2 of the user A in the peer-to-peer connection to continue the chat.

In this manner, even if the user, for example, A changes its device during chatting (for example, from a desktop PC to a laptop PC), the changed IP address is transmitted to the key telephone unit 21. In accordance with a list table, such as the buddy table, the key telephone unit 21 distributes a new IP address to other terminals. As a result, the chatting can be continued. In this case, it is needless to say that each of the clients PC-1 and PC-2 of the user A has an IP address table which stores IP addresses of other user terminals.

On the other hand, the key telephone unit 21 according to the above-mentioned exemplary embodiment refers to the list table (for example, the buddy list table) when it receives the presence information including the IP address, from the client PC-1 of the user A. The key telephone unit 21 transmits the presence information including the received IP address to the client PC-3 of the user B included in the list table. Thereafter, the chat or chat communication is performed between the client PC-2 of the user A and the client PC-3 of the user B in the peer-to-peer connection. Thus, the key telephone unit has a function of making the client PC-1 and the client PC-3 perform a chat communication in the peer-to-peer connection.

Moreover, when the user A moves from the client PC-1 to the PC-2, the key telephone unit 21 also refers to the list table when the it receives the presence information of the user A which includes the IP address of the client PC-2 and which is sent from the client PC-2 of the user A. The received presence information including the IP address is transmitted from the key telephone unit 21 to the client PC-3 of the user B included in the list table.

Thus, the key telephone unit 21 has a function of making the client PC-1 of the user A and the client PC-3 of the user B continue as a chat between the client PC-2 of the user A and PC-3 of the user B in the peer-to-peer connection. At any rate, the chat communication between the first user terminal PC-1 and the second user terminal PC-3 is taken over as a chat communication between the third user terminal PC-2 and the second user terminal PC-3.

In the chat system according to the exemplary embodiment, let either one of the clients (PC-1, PC-2, PC-3) be in an offline state during the chat communication. In this event, chat data are maintained in the client PCs except the PC of the offline state. When the PC of the offline state is returned back to an online state, the chat data are transferred or taken over from the PC maintaining the chat data to the PC returned back to the online state.

In this event, the key telephone unit 21 mentioned above has a key telephone program which responds to the presence information including the IP address and refers to the list table. Furthermore, the key telephone program selects a recipient client terminal from the list table and transmits the presence information including the received IP address to the recipient user terminal.

In the above embodiment, when the chat application is started, the key telephone unit 21 obtains an IP address of a user terminal and distributes it as presence information to registrants in the buddy list table. However, with another configuration of the present invention, when the chat application is started, the user terminal chat program may inquire of the key telephone unit 21 an IP address of a chat addressee or recipient to obtain the IP address.

As described above, the presence server included in the key telephone unit 21 receives the presence information including the IP address and provides the presence information to the user terminal(s) listed on the buddy list table. The user terminal can refer to the obtained presence information and can perform a chat in the peer-to-peer connection by using the IP address without use of a chat server. In any case, the exemplary embodiment according to the present invention makes it possible to perform chat communication without any chat server.

As mentioned above, when the user A moved the client PC-1 of the IP address “xx.xx.xx.xx” to the PC-2 of the IP address “yy.yy.yy.yy” during chatting between the client PC-1 of the user A and the client PC-3 of the user B, the presence information including the IP address “yy.yy.yy.yy” of the client PC-2 is sent from the client PC-2 to the key telephone unit 21. In this event, chat data are transferred from the PC-1 to the PC-2 in the peer-to-peer connection.

This structure is advantageous in that the new PC-2 can continue the chat by looking at previous communication contents on a display device. In this case, it is to be noted that the IP address “yy.yy.yy.yy” of the client PC-2 included in the presence information is transmitted from the client PC-2 to the key telephone unit 21 and the key telephone unit 21 transmits the presence information including the IP address “yy.yy.yy.yy” to the client PC-3 of the user B.

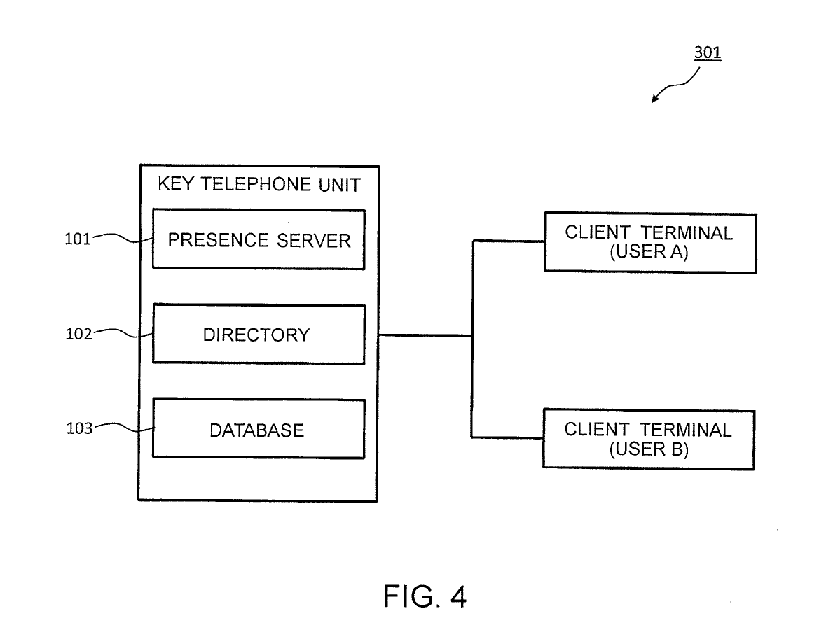

FIG. 4 is a block diagram showing a chat system shown in FIG. 2. As shown in FIG. 4, the key telephone unit 21 includes a presence server 101, a directory 102, and a database 103. The key telephone unit 21 is connected to a client terminal of the user terminal A and a client terminal of the user terminal B.

The database 103 of the key telephone unit 21 stores therein a buddy list table as shown in FIG. 5. For example, when the presence server 101 receives an IP address from the user terminal B, it accesses to a buddy list corresponding to the user terminal B. Subsequently, the presence server 101 selects the registered user terminal (e.g., the user terminal B) to include the received IP address in corresponding presence information, and transmits the presence information to an addressee(s), i.e., the user terminals A, C and D.

Each of the addressees, e.g., the user terminal A, stores the IP address of the user terminal B. Thus, the user terminal A can chat with the user terminal B.

FIG. 6 shows an IP address table stored in each of terminals (i.e., clients PC-1, PC-2, PC-3, and the like). This example shows an IP address table of the user terminal A. As shown in FIG. 6, the IP address table of each of the user terminals includes IP addresses of any clients that have had communication with that user terminal (e.g., the user terminal B) as well as its own IP address.

Specifically, a user terminal chat program of a user terminal has an IP address table including a list of registered user terminals and IP addresses of them. The user terminal chat program also has a function of transmitting an IP address of a user terminal selected from the list of the registered user terminals (as an addressee of chat data) as well as its own IP address. Thus, there can be provided a chat system that can achieve peer-to-peer chat communication between user terminals.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. For example, the aforementioned key telephone unit may be any device that can eliminate the need for a chat server. Therefore, the key telephone unit may include an IP telephone device.

What is claimed is:

1. A chat system comprising:
a plurality of user terminals assigned with IP addresses, respectively; and
a key telephone unit accommodating the plurality of the user terminals;
wherein:
the key telephone unit is configured to:
receive presence information from a first user terminal in the plurality of the user terminals, the presence information including the IP address assigned to the first user terminal;
refer to a list within a list table to pick up a second user terminal included in the list;
transmit the presence information including the IP address received from the first user terminal to the second user terminal; and
make the first and the second user terminals perform a chat communication in a peer-to-peer connection;
wherein;
when a user of the first user terminal moves from the first user terminal to a third user terminal, the third user terminal
transmits, to the key telephone unit, presence information of the user which includes an IP address of the third user terminal and
the key telephone unit
refers to the list within the list table and
transmits, to the second user terminal included in the list, the presence information including the received IP address of the third user terminal;
wherein:
chat data between the first user terminal and the second user terminal
are transferred from the first user terminal to the third user terminal in a peer-to-peer connection and
are taken over as chat data between the third user terminal and the second user terminal, and
the peer-to-peer chat communication between the first and the second user terminals is continued as a peer-to-peer chat communication between the third and the second user terminals.

2. The chat system as recited in claim 1,
wherein each of the user terminals comprises an IP address table which stores IP addresses assigned to the other user terminals.

3. A key telephone unit accommodating a plurality of user terminals assigned with IP addresses, respectively,
the key telephone unit being configured to:
receive presence information from a first user terminal in the plurality of the user terminals, the presence information including the IP address assigned to the first user terminal;
refer to a list within a list table to pick up a second user terminal included in the list;
transmit the presence information including the IP address received from the first user terminal to the second user terminal; and
make the first and the second user terminals perform a chat communication in a peer-to-peer connection;
wherein;
when a user of the first user terminal moves from the first user terminal to a third user terminal, the key telephone unit is further configured to:
receive, from the third user terminal, presence information of the user which includes an IP address of the third user terminal;
refer to the list within the list table and
transmit, to the second user terminal included in the list, the presence information including the received IP address of the third user terminal; and
make the peer-to-peer chat communication between the first and the second user terminals continue as a peer-to-peer chat communication between the third and the second user terminals.

4. The key telephone unit as recited in claim 3, further comprising:
a presence server which distributes the presence information including the IP address.

5. The chat system as recited in claim 1,
wherein,
when either one of the first through the third user terminals is put into an offline state, the chat data are maintained in the user terminals except the user terminal of the offline state,
when the user terminal of the offline state is returned back to an online state, the chat data are transferred from the user terminal maintaining them to the user terminal returned back to the online state.

6. A non-transitory computer readable recording medium comprising a program which is used in the key telephone unit claimed in claim 3
to respond to the presence information including the IP address received from the first user terminal,
to select the second user terminal from the list table, and
to output the presence information including the received IP address to the second user terminal.
